(19) United States
(12) Patent Application Publication
(10) Pub. No.: US 2020/0317446 A1
(43) Pub. Date: Oct. 8, 2020

(54) EXPANDABLE AUTONOMOUS STORAGE AND RETRIEVAL TOWER

(71) Applicant: Walmart Apollo, LLC, Bentonville, AR (US)

(72) Inventors: David G. Tovey, Rogers, AR (US); Bruce W. Wilkinson, Rogers, AR (US); Paul Edward Durkee, Centerton, AR (US); Kurt William Robert Bessel, Mexico, NY (US)

(21) Appl. No.: 16/843,325

(22) Filed: Apr. 8, 2020

Related U.S. Application Data
(60) Provisional application No. 62/830,930, filed on Apr. 8, 2019.

(51) Int. Cl. B65G 1/137; B65G 1/127; G06Q 10/08; G06Q 10/06; G06K 7/14; G05B 19/418

(52) U.S. Cl. CPC B65G 1/1371; B65G 1/127; G06Q 10/087; G06Q 10/06311; G06Q 30/0633; G06K 7/1413; G06K 7/1417; G05B 19/4189; G06Q 10/0836

(57) ABSTRACT

An autonomous storage and retrieval tower with dynamic resizing of available space is discussed.

### RELATED APPLICATION

This application claims benefit of priority to U.S. Provisional Application No. 62/830,930 filed Apr. 8, 2019, the contents of which is hereby incorporated in its entirety.

### BACKGROUND

Storage and retrieval towers, also known as automated kiosks or pickup towers, are used in some retail facilities to enable customers to retrieve items from the pickup towers. The towers are configured to store items until a customer shows up to claim them at which point the items are identified and may be provided to the customer using a variety of automated and/or mechanical mechanisms.

### BRIEF DESCRIPTION OF THE DRAWINGS

The accompanying drawings, which are incorporated in and constitute a part of this specification, illustrate one or more embodiments of the disclosure and, together with the description, help to explain the disclosure. The drawings are not necessarily to scale, or inclusive of all elements of a system, emphasis instead generally being placed upon illustrating the concepts, structures, and techniques sought to be protected herein. In the drawings:

FIG. 1A is a schematic diagram of an exemplary storage tower in accordance with an exemplary embodiment;

FIG. 1B is a schematic diagram of an interior of a storage tower in accordance with an exemplary embodiment;

FIG. 2 is a schematic diagram of an arrangement of storage towers in accordance with an exemplary embodiment;

FIG. 3 is a schematic diagram of a storage receptacle in a storage tower in accordance with exemplary embodiments;

FIG. 4 is a schematic diagram of an exterior of an embodiment of the storage tower in accordance with an exemplary embodiment;

FIG. 5 is an exemplary graphical user interfaces (GUI) in accordance with an exemplary embodiment;

FIG. 6 is a block diagram illustrating an autonomous object storage and retrieval system in accordance with an exemplary embodiment;

FIG. 7 is a block diagram illustrating of an exemplary computing device in accordance with an exemplary embodiment; and

FIG. 8 is a flowchart illustrating an exemplary process in accordance with an exemplary embodiment.

### DETAILED DESCRIPTION

Exemplary embodiments provide an autonomous storage and retrieval tower with dynamic resizing of available space. The autonomous storage and retrieval tower receives, stores, and dispenses physical items. For example, a customer may order physical items online and select the “pick-up” option at checkout. When the ordered physical items arrive at a store local to the customer, a store associate or an automated mechanism such as an autonomous vehicle may load the ordered physical items into the autonomous storage and retrieval tower. When the customer arrives at the store, the customer can proceed to the autonomous storage and retrieval tower and enter or scan a code associated with the order. The tower identifies any stored items associated with the customer and the customer may then promptly receive the ordered physical items from the autonomous storage and retrieval tower.

The autonomous storage and retrieval tower includes a housing and trays oriented horizontally within the housing. Each tray is configured to support at least one physical item. In one embodiment, the housing includes horizontally positioned transport apparatuses running vertically along one or more walls of the housing, where a transport apparatus is configured to support a tray. In an embodiment, the tower further includes a storage receptacle for receiving physical items to be stored by the autonomous storage and retrieval tower and/or for outputting physical items from the autonomous storage and retrieval tower. The tower includes and/or is in communications with at least one computing device in communication with one or more databases. The databases are configured to store item files associated with physical items and rules for organizing the trays. The item files include data such as, but not necessarily limited to, physical characteristics and dimensions of the associated item.

In one embodiment, the transport apparatuses may be movably affixed to vertical supports (e.g., shafts or railings) within the housing. Movements of the transport apparatuses along the vertical supports within the housing are programmatically controllable so as to change a distance between vertically adjacent transport apparatuses. Following a command received from a computing device, a controller may move a transport apparatus up or down on a vertical support through a variety of mechanical means so as to bring the transport apparatus nearer or farther away from an adjacent transport apparatus.

In another embodiment, a tray and/or transport apparatus may be repositioned at a different height on the vertical supports following a command received from a computing device to create more or less room with respect to an adjacent tray and/or transport apparatus affixed to the same vertical supports.

The tower further includes an assignment module executable by the computing device. The assignment module tracks physical items stored within the autonomous storage and retrieval tower. The assignment module is in communication with a fulfillment system used to receive and fulfill customer orders, such as orders submitted online. Orders are received through the fulfillment system, including orders for physical items being shipped into a store for pick-up by a customer. The assignment module receives, from the fulfillment system, an identifier associated with an inbound physical item to be stored in the tower. The assignment module retrieves, from the database, an item file associated with the identifier of the inbound physical item. The item file has an item dimension attribute associated with the inbound physical item. For example, in some embodiments, each item dimension attribute includes an order-cube attribute associated with the inbound physical item. The order-cube attribute is a length, a width, and a height of the inbound physical item. The order-cube attribute identifies a volume consumed by the inbound physical item. The item files further include item dimension attributes associated with the physical items already stored in the tower. The assignment module analyzes an amount of available space in the tower on the trays based on the item dimension attribute of the inbound physical item and the item dimension attributes associated with the physical items already stored in the tower. The assignment module identifies a lack of available space in the tower to store the inbound physical item based on the analysis. The assignment module performs at least one action based on the analysis and a set of rules to store the inbound physical item.

In one embodiment, the at least one action includes re-orienting a physical item stored in the tower to a different orientation on a tray. In still further embodiments, the at least one action includes re-routing the inbound physical item to a different autonomous storage tower or a separate storage location where more storage space exists. In still further embodiments, the at least one action includes re-routing at least one physical item already stored in the tower to a different autonomous storage tower or a separate storage location so as to create additional space in the tower.

In an additional embodiment, the at least one action includes the assignment module changing a location of at least one transport apparatus within the housing to make available space in the tower sufficient to store the inbound physical item. For example, a command may be transmitted to a controller configured to control movement mechanisms within the tower such that the transport apparatus is moved farther away from an adjacent transport apparatus so as to increase the amount of available space sufficiently to allow for storage of an incoming item.

In another embodiment, the assignment module may transmit a command to change a vertical height of a tray on the vertical supports to create more or less room with respect to an adjacent tray. For example, a command may be transmitted to a controller configured to control movement mechanisms within the tower such that the tray is moved to a different transport apparatus at a different vertical height on the vertical supports. Alternatively, the command may be sent to a mobile device or other device of a worker in the facility to manually change the height of the trays within the tower.

In further embodiments, the at least one action includes the assignment module notifying an employee to re-orient a physical item stored in the tower to a different orientation. For example, in some embodiments, the autonomous storage and retrieval tower includes a screen configured to display a depiction of the item with a different orientation of the item as part of the notification. For example, an item in a box container may fit in an available storage space if it is turned horizontally onto its side instead of being stored vertically with the box bottom touching the tray. In one embodiment, rules for the item may be consulted before an instruction to re-orient the item is transmitted.

In still further embodiments, the at least one action includes the assignment module transmitting a notification to a customer associated with a physical item to pick up the physical item stored in the tower. In some embodiment, the assignment module transmits a notification, such as an e-mail or text message, to a customer that includes a code necessary to retrieve the item from the autonomous storage and retrieval tower. The customer can enter or scan the code at the autonomous storage and retrieval tower to retrieve the physical item.

In some embodiments, the rules in one or more databases accessible to the computing device and the assignment module include rules indicating a length of time a physical item may be stored in the tower before being removed, rules indicating specified categories associated with physical items stored in the tower designating an order in which the physical items are removed from the tower to make space in the tower, rules indicating whether a physical item stored in the tower can be re-oriented, and/or rules indicating whether a physical item stored in the tower can support weight. For example, the rules may include whether the physical item can be tipped on its side without resulting in damage to the physical item and other physical items. The rules may maximize vertical or horizontal space to create room for the inbound physical item, such as creating space within the autonomous storage and retrieval tower for another tray to hold the inbound physical item, creating space on a tray already within the autonomous storage and retrieval tower upon which to place the inbound physical item or other physical items, or to stack the inbound physical item or other physical items.

In some embodiments, the assignment module performs the analysis by analyzing a location of each tray that holds a physical item based on an item dimension attribute of the physical item, and analyzing categories of physical items stored within the tower.

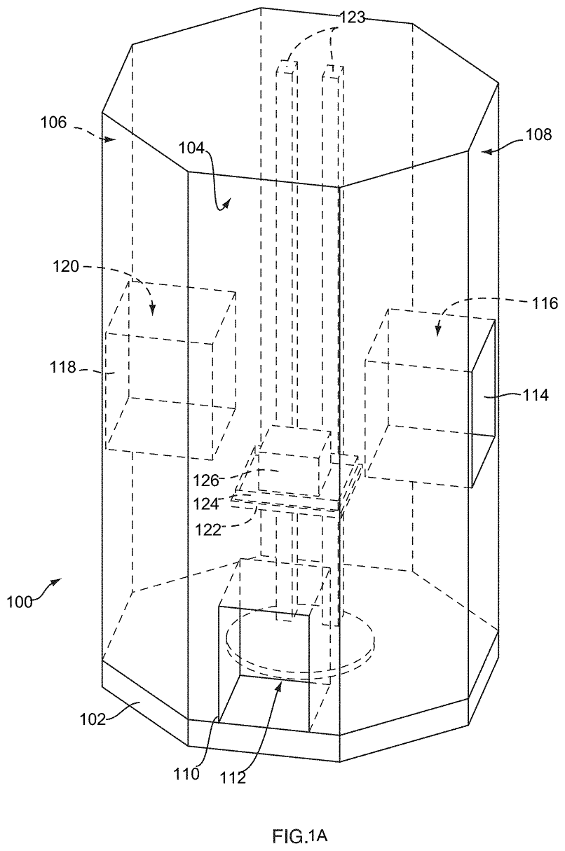

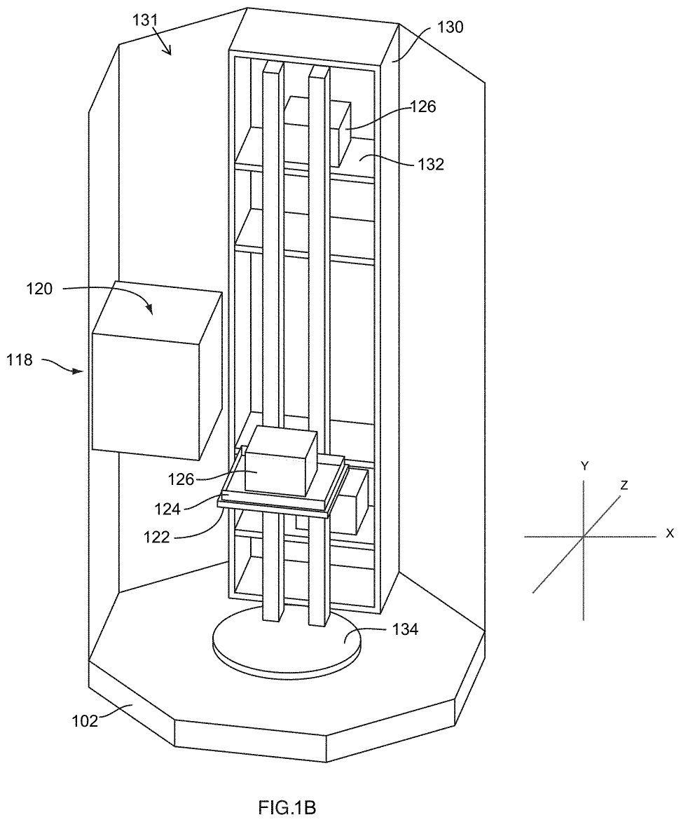

FIG. 1A is a schematic diagram of an exemplary storage tower 100 in accordance with an exemplary embodiment. The storage tower 100 can include housing having a base 102 coupled to side walls or surfaces extending from the base 102. In the present example, the side walls or surfaces of the storage tower 100 can form octagonal cylinder or column such that there are eight side walls or surfaces including a front face 104, a first side face 106, and a second side face 108. A front opening 110 can be disposed on the front face 104. A first side opening 118 can be disposed on the first side face 106. A second side opening can be disposed on the second side face 108. It can be appreciated that the openings, front opening 110, first side opening 118, and second side openings 114, can have retractable doors, windows, or panels to selectively cover the openings 110, 114, and 118.

An interior of the storage tower 100 can include a transport apparatus 122 coupled to shafts or railings 123. The transport apparatus 122 can be configured to transport and support the physical item 126 or a tray 124, which is configured to support physical items (e.g., the physical item 126). The transport apparatus 122 is further configured to move along the railings 123 along the y-axis. The interior of the storage tower 100 can further include a front storage receptacle 112 aligned with and/or coupled to the front opening 110. A first side storage receptacle 120 can be aligned with and/or coupled to the first side opening 118. A second side storage receptacle 116 can be aligned with and/or coupled to the second side openings 114. The front storage receptacle 112, first side storage receptacle 120, and second side storage receptacle 118 can each include a storage volume, configured to store objects, such as the physical item 126 and/or tray 124. The front opening 110, first side opening 118 and second side openings 114 can provide access to the storage volume of the front storage receptacle 112, first side storage receptacle 120, and second side storage receptacle 118, respectively.

FIG. 1B is a schematic diagram of an interior of a storage tower 100 in accordance with an exemplary embodiment. The interior of the storage tower 100 can include eight interior walls 131 defined by the side walls or surfaces of the housing. The interior of the storage tower 100 can include one or more supporting unit 130, the transport apparatus 122, the railings 123, and a rotating base 134. The railings 123 can be coupled to the rotating base 134. The transport apparatus 122 can be configured to support and transport the tray 124 between supports of a supporting unit 130 and one of the storage receptacles. The tray 124 can support the physical item 126. The transport apparatus 122 can be coupled to the railings 123. The transport apparatus 122 can extend perpendicularly from the railings 123. As an example, the transport apparatus 122 can be a pallet. The railings 123 can operate as a boom to lower and raise the transport apparatus 122. The rotating base 134 can rotate the railings 123, and therefore, the transport apparatus 122 360 degrees about a center axis of the rotating base.

The supporting unit 130 includes horizontally adjacent transport apparatuses configured to store and support trays (e.g., tray 124). For example, as illustrated, tray 132 on which physical item 126 is disposed is supported within the supporting unit 130.

As noted above, in one embodiment the transport apparatus 122 may be movably affixed to vertical supports on the interior walls 131 of the housing and may be moved up and down in a vertical direction. The supporting unit 130 can be disposed along one or more of the interior walls 131 of the storage tower 100. For example, the supporting units 130 can be disposed along one interior wall, each interior wall, or a subset of the interior walls of the storage tower 100. Each supporting unit 130 is able to move within the housing to change a distance between adjacent supporting units 130. In some embodiments, a location of a supporting unit 130 is changed to make available space in the tower sufficient to store an inbound physical item.

As an example, the transport apparatus 122 can receive instructions to load a physical item 126 from the supporting unit 130 onto the transport apparatus 122 and load the physical item 126 into a first side receptacle 120. The rotating base 134 can be configured to rotate the railings 123 circumferentially around the interior of the storage tower 100 so that the railings 123 are parallel to the appropriate supports within the supporting unit 130. The transport apparatus 122 can vertically move up and down the railings 123 to align itself with a supporting unit 130 on which the requested physical item 126 is disposed.

The transport apparatus 122 can pick up either the physical item 126 or the tray 124 supporting the physical item. The transport apparatus 122 can traverse along and rotate about the railings 123, transport and deposit the physical item 126 or the tray 124 and physical item 120 in the first side receptacle 120. The physical item 126 can be stored in the first side receptacle 120, until ejected from the first side opening 118.

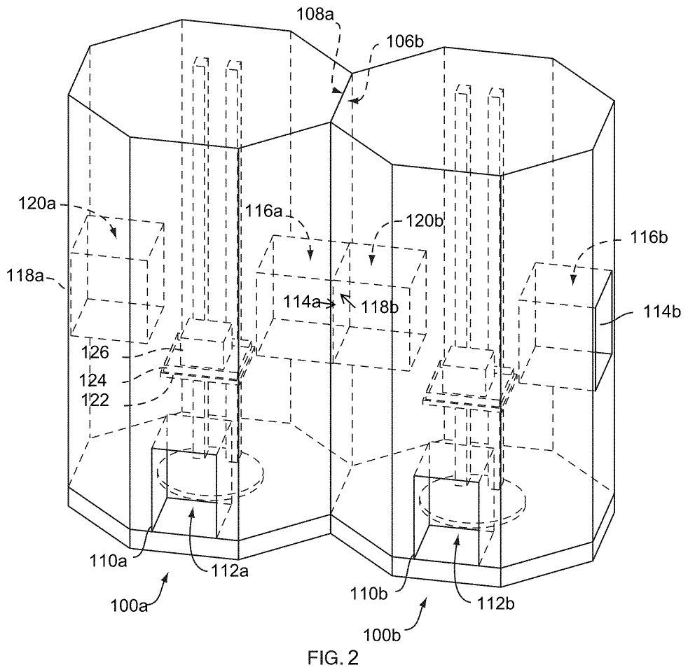

FIG. 2 depicts an exemplary alternative arrangement of storage towers. As a non-limiting example, storage tower 100a can be disposed adjacent to storage tower 100b. The first side face 106a of the storage tower 100a can be aligned with, and adjacent to, the second side face 108b of the storage tower 100b. The second side opening 114b disposed on the second side face 108b of the storage tower 100b can be aligned with, and adjacent to, the first side opening 118a disposed on the first side face 106a of the storage tower 100a. The storage towers 100a and 100b can be directly adjacent to one another or can be spaced away from each other. Any number of storage towers can be disposed within a specified proximity of one another. This arrangement of storage towers may be used to re-route the inbound physical item to a different autonomous storage tower or re-route a physical item 126 stored in the storage tower 100a (or storage tower 100b) to storage tower 100b (or storage tower 100a) to make space for the inbound physical item.

In one embodiment, the assignment module associated with storage tower 100a (or storage tower 100b) can query its own records to confirm whether it is storing the physical item 126. The transport apparatus 122 of storage tower 100a (or storage tower 100b) can transport the physical item 126 to the first side storage receptacle 120a. The transport apparatus 122 can deposit the physical item 126 in the front storage receptacle 112a (or storage tower 112b). The physical item 126 can be ejected from the front storage receptacle 112a (or storage tower 112b) through the front opening 110b (or storage tower 110b).

As an example, storage tower 100b may be scheduled to receive an inbound physical item. The assignment module for storage tower 100b can confirm physical item 126 is in storage tower 100b and can be removed to make space for the inbound physical item. The transport apparatus 122 of storage tower 100b can transport the physical item 126 to the second side storage receptacle 120b. The transport apparatus 122 of storage tower 100b can deposit the physical item 126 in the first side storage receptacle 120b of the storage tower 100b.

The physical item 126 can be transferred from the first side storage receptacle 120b, of the storage tower 100b, through the first side opening 118b of the storage tower 100b through the second side opening 114a into the storage volume of the second side storage receptacle 116a of the storage tower 100a. The physical item 126 can be transferred from the second side storage receptacle 116a to the transport apparatus 122, of the storage tower 100a. The transport apparatus 122 can traverse up or down the railings 123 and store the physical item 126 within the storage tower 100a. An alert can be rendered on the graphical user interface of the display of storage tower 100a indicating the physical item 126 is disposed in storage tower 100a. The alert can also be transmitted from the storage tower 100a to a user device or terminal.

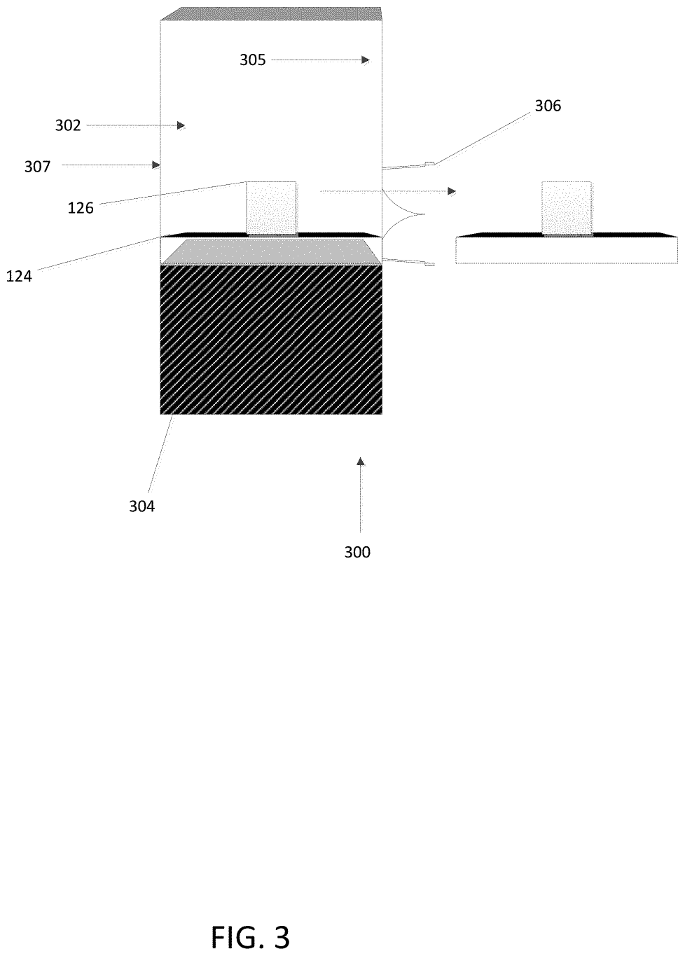

FIG. 3 is a schematic diagram of a storage receptacle 300 in a storage tower in accordance with exemplary embodiments. One or more storage receptacles 300 can be disposed in the storage tower at different locations as described herein. For example, the storage receptacle 300 can be disposed in a front, a first side, or a second side of the storage tower. The storage receptacle 300 can include an interior storage volume 302 and a base 304 within the interior storage volume 302. The base 304 can support a tray 124, which can support a physical item 126. A first (front) side 305 of the storage receptacle 300 can include a door 306. A second (back) side 307 of the storage receptacle 300 can be an open face. The storage receptacle 100 can be configured to receive and eject the tray 124 and physical item 126 from the door 106 on the front side and through the open face of the back side 107. The door 306 can be a sliding door (sliding horizontally or vertically), a rotating door, a hinged door, and/or a double door.

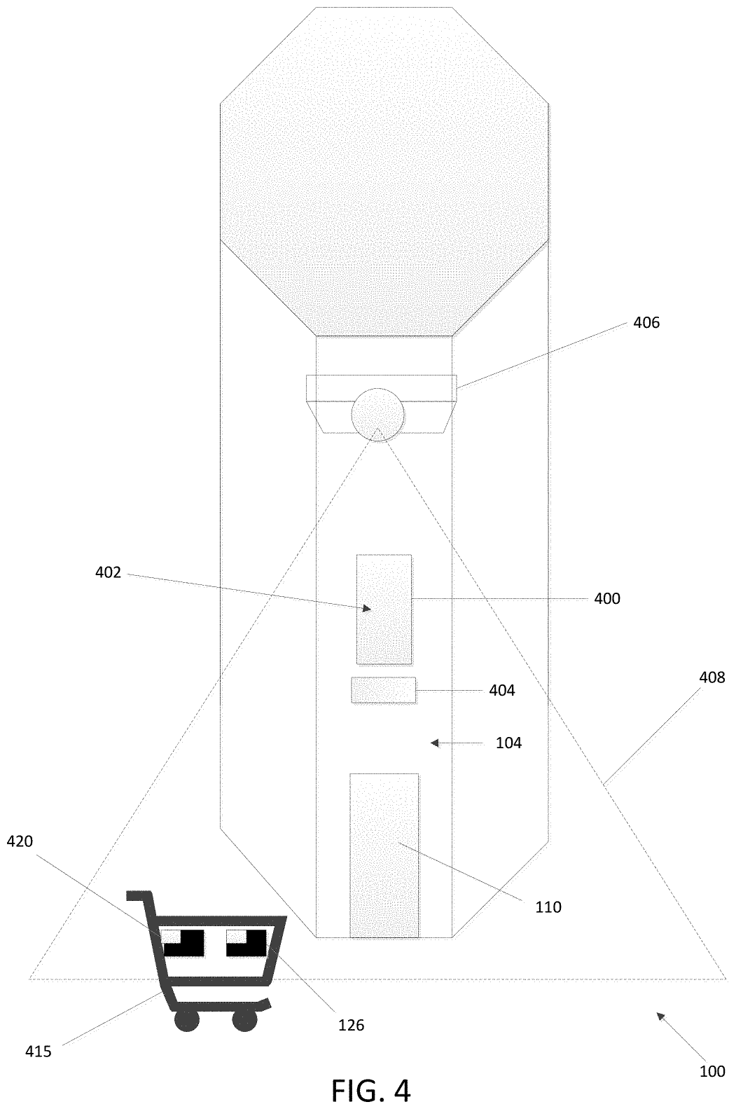

FIG. 4 is a schematic diagram of an exterior of an embodiment of the storage tower 100 in accordance with an exemplary embodiment. An interactive display 400 can be disposed on the storage tower 100. The interactive display 400 can be disposed on the front surface 104 with respect to the front opening. An input device 404 can also be disposed on the storage tower. The input device 404 can be disposed on the front surface 104 with respect to the front opening 110. The input device 404 can be one or more of, an optical scanner, a keyboard/keypad, and image capturing device.

The interactive display 400 can render a graphical user interface (GUI) 402. The GUI 402 can display information associated with a request for dispensing a physical item through the front opening of the storage tower. As an example, a user can input information associated with a request for dispensing a physical item. The information can be an identifier, a name, a username, a pin number or any suitable information that can be used to identify the physical item to be retrieved or stored. As a non-limiting example, the user can enter the information, via a touchscreen display incorporated in the interactive display 402. Alternatively, or in addition to, the interactive display 402 can have multiple input devices such as a keyboard, mouse, joystick, touchpad, or other devices configured to interact with the interactive display 402, such as the input device 404. The user can input identification information using the input device 404. The GUI 402 may also display a depiction of a physical item stored in the storage tower 100 placed in a different orientation on a tray.

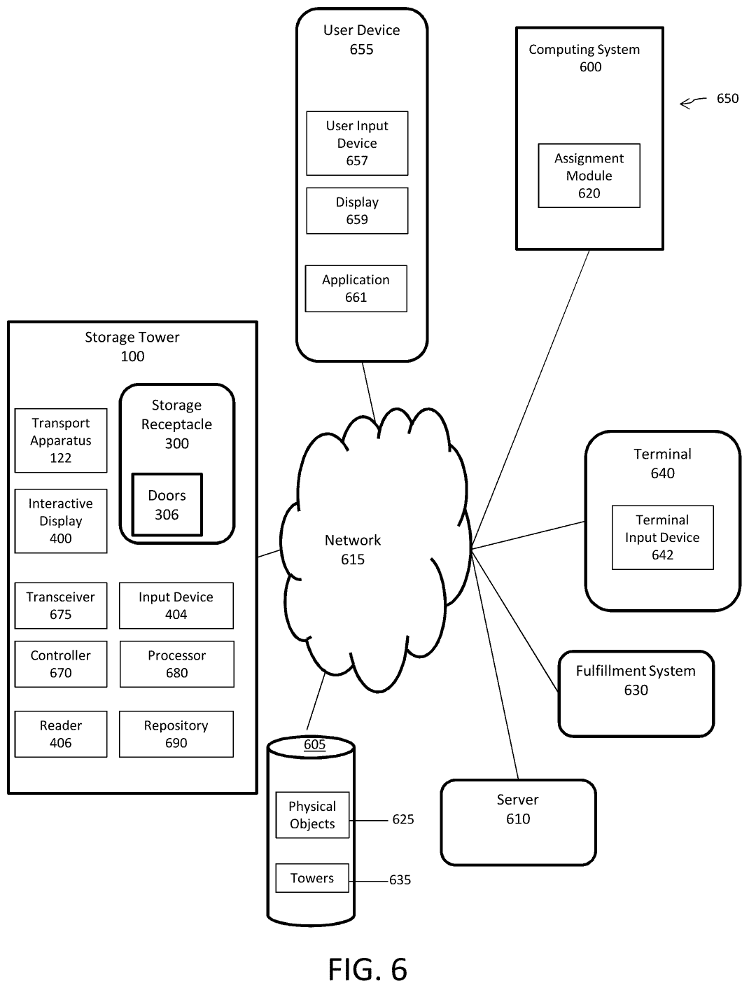

The user can also scan a machine-readable element encoded with an identifier associated with the physical item, using the input device 404. As an example, the input device 404 can be an optical scanner or an image capturing device. The input device 404 can scan/capture and decode the identifier from the machine-readable element. The machine-readable element can be a barcode or a QR code. The input device 404 can transmit the identifier to the interactive display. The interactive display 400 can receive the information associated with the request and transmit the information to a computing system, an example of which is described in greater detail with respect to FIG. 6.

In one embodiment, the user can request to dispense a physical item disposed in the storage tower 100 or another storage tower. The user can input identification information associated with the using the interactive display 400 and/or input device 404. The identification information can be transmitted to the computing system. The computing system can instruct the storage tower 100 within which the physical item is disposed to dispense the physical item. In the event the physical item is disposed in the storage tower 100, the storage tower 100 can dispense the physical item through the front opening 110 of the storage tower 100. In the event the physical item is stored in a different storage tower, the computing system can instruct the storage tower 100 to display a graphical user interface (GUI) rendering instructions on the interactive display 402 for retrieving the physical item from a different tower or location. The instructions can include the location of the different tower and/or a time frame in which the physical item may be available for retrieval.

In one embodiment, a reader 406 can be disposed on the front surface 104 of the storage tower 100. The reader 406 can detect a physical items 126 passing by the storage tower 100 or approaching the storage tower 100, within a given field-of-view or radius 408. As an example, the physical items 126 can be passing by in a cart 415. The reader 406 can be configured read and decode identifiers 420 disposed on physical items.

In one embodiment, the identifiers 420 can be encoded in machine-readable elements on labels which are disposed on the physical items 126. The machine-readable elements can be barcodes or QR codes. The reader 406 can be triggered by a motion sensor and can scan physical items as the reader 406 detects motion within the given field-of-view or radius 408 and scans for identifiers 420. The reader 408 can transmit the identifiers to a computing system.

In one embodiment, the identifiers 420 can be encoded in RFID tags. The reader 406 can be embodied as an RFID reader. The reader 406 can detect the RFID tags as the RFID tags pass by the storage tower 100. The reader 406 can scan and decode the identifiers 420 from the RFID tags as the RFID pass through the given field-of-view or radius 408.

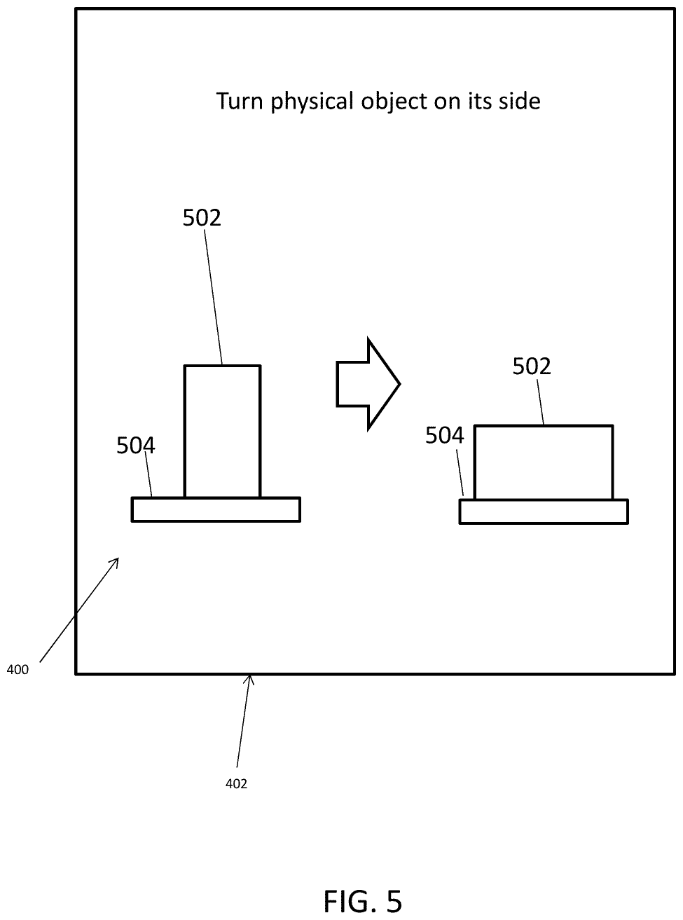

FIG. 5 illustrates an exemplary graphical user interface (GUI) to be rendered on a display of a storage tower. As described above, the storage tower can include a display 400 and a GUI 402. The GUI 402 of the display 400 can display a depiction of a physical item 502 stored in the storage tower 100 placed in a different orientation on a tray 504.

FIG. 6 illustrates an exemplary autonomous object storage and retrieval system 650 in accordance with an exemplary embodiment. The autonomous object storage and retrieval system 650 can include one or more databases 605, one or more servers 610, one or more computing systems 600, storage tower(s) 100 (which may include integrated computer system 600), one or more user devices 655, and one or more terminals 640. The assignment module 620 can implement the autonomous object storage and retrieval system 650.

In an example embodiment, one or more portions of the communications network 615 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 610 includes one or more computers or processors configured to communicate with the computing system 600, the databases 605, storage tower 100, terminals 640 and user devices 655 via a communications network 615. The server 610 hosts one or more applications configured to interact with one or more components of computing system 600 and/or facilitates access to the content of the databases 605. The databases 605 may store information/data, as described herein. For example, the databases 605 can include physical items database 625 and a towers database 635. The physical items database 625 can store information associated with physical items. For example, in an exemplary embodiment, the databases 605 store an item file for each physical item stores in the storage tower 100. The databases 605 also include rules for organizing the trays. The towers database 635 can store information associated with the storage towers location and physical item disposed in the storage towers. The databases 605 can be located at one or more geographically distributed locations from the computing system 600. Alternatively, the databases 605 can be located at the same geographically as the computing system 600.

The storage tower 100 can include one or more of the storage receptacles 300, the transport apparatus 122, the tray 124, the interactive display 400, the input device 404, the controller 670, the transceiver 675, processor 680, and a repository 690. The one or more storage receptacles 300 can each include a door 306. The transceiver 675 can transmit and receive data via the network 615, and/or can transmit data directly to and receive data directly from directly the computing system 600, the terminal 640, the server 610, and/or the user device 655. The controller 670 can control the operations of transport apparatus 122, door 306, interactive display 400, and input device 404, based on received data from the input device 404, the reader 406, and/or the transceiver 675. The processor 680 can process information received via the input device 404, the reader 406, and/or the transceiver 675 and can execute queries on the repository 690. The repository 690 can store information associated with physical items stored in the storage tower 100.

In one embodiment, terminals 640 and storage tower 100 can be disposed throughout a facility. The terminals 640 can include a terminal input device 642. The terminal input device 642 can be a scanner, keyboard device, multi-touchscreen, or any other type of input device. The terminal input device 642 can receive input associated with physical items. For example, the terminal input device 642 can include an optical scanner. The terminal input device 642 can scan machine-readable elements disposed on each of the physical items. Each of the machine-readable elements can be encoded with an identifier associated with the physical item. The terminal 640 can transmit the received input associated with the physical items to the computing system 600.

The computing system 600 can execute the assignment module 620 in response to receiving an identifier from the fulfillment system 630. The identifier is associated with an inbound physical item to be stored in the storage tower 100. In one embodiment the assignment module 620 may query the databases 605 to retrieve a first item file associated with the inbound physical item using the received identifier associated with the inbound physical item. The assignment module 620 retrieves, from the databases 605, a first item file associated with the identifier associated with the physical item. The first item file has a first item dimension attribute associated with the inbound physical item. The assignment module 620 retrieves, from the databases 605, item files associated with physical items stored in the storage tower 100. The item files include item dimension attributes associated with the physical items stored in the storage tower 100. The assignment module 620 analyzes an amount of available space in the tower on the trays based on the first item dimension attribute, the item dimension attributes associated with the physical items already stored in the tower and the amount of space in the tower. The assignment module 620 identifies a lack of available space in the storage tower 100 to store the inbound physical item based on the analysis. The assignment module 620 performs at least one action based on the analysis and a set of rules on how to store the inbound physical item.

For example, the assignment module 620 analyzes an amount of available space in the storage tower 100 on the trays based on the volume of the inbound physical item and the volume of the physical items stored in the storage tower 100. The assignment module 620 identifies a lack of available space (e.g., available volume) in the storage tower 100 to store the inbound physical item based on the analysis. For example, the assignment module may determine a current available amount of storage space between two vertically adjacent trays based on the trays current location to determine a total storage volume between the trays and then determine how much of that total volume is already occupied based on the volume taken up by the items currently stored on the bottom tray. Based on the analysis and the rules, the assignment module 620 performs at least one action to store the in-bound physical item. For example, the assignment module 620 may transmit a notification to an employee to re-orient a physical item stored in the tower to a different orientation on a tray. In still further embodiments, the assignment module 620 may re-route the inbound physical item to a different autonomous storage tower or a separate storage location. In still further embodiments, the at least one action includes re-routing at least one physical item stored in the tower to a different autonomous storage tower.

In one embodiment, storage tower 100 can transfer one or more physical items to another storage tower. In one embodiment, a storage receptacle 300 (e.g., first side storage receptacle) of the storage tower 100 is configured to be aligned with a storage receptacle (e.g., second side storage receptacle) of a second storage tower. The controller 670 of storage tower 100 can control the transport apparatus 122 of storage tower 100 to pick-up the one or more physical items stored on a tray in the storage tower 100, transport the one or more physical items, and deposit the one or more physical items in the storage receptacle of the second storage tower aligned with the storage receptacle 300 of storage tower 100. The second storage tower can receive the one or more physical items in the storage receptacle. A controller of the second storage tower can control a transport apparatus of the second storage tower to pick-up the one or more physical items, transport the one or more physical items, and deposit the one or more physical items within the second storage tower.

In some embodiments, the controller 670 of storage tower 100 can generate and transmit an alert. In one embodiment, the alert can include information associated with a physical item. The controller 670 can render the alert on the display 400 and/or transmit the alert to be rendered on a display 659 of a user device 655. The user device 655 can be associated with a user at the terminal 640 receiving input associated with the physical items. In one embodiment, the user device 655 can execute an application 661. After a user authorizes and/or opts in to the function of the application, the storage tower 100 can interface with the application 661 to transmit the alert.

In embodiment, a reader 406 can be disposed on the storage tower 100. The reader 406 can read one or more machine-readable elements or one or more radiofrequency identifier (RFID) tags disposed on the physical items, as a cart (e.g., cart 415 as shown in FIG. 4) including the physical items traverses past the storage tower 100. The storage tower 100 can transmit the one or more identifiers encoded in the machine-readable elements or RFID tags disposed on the physical items, decoded by the reader 406, to the computing system 600.

In embodiment, the user device 655 can execute an application 661 associated with the facility. For example, a user of the user device can install the application 661 on the user device and authorize and/or opt-in to functionality of the application. In response to executing the application 661 after the user authorizes and/or opts in to the application 661, the user device 655 can receive input associated with the physical items, via the user input device 657. The user input device 657 can be an optical scanner, keyboard, multi-touchscreen, or any other type of input device. The input can be identifiers associated with each of the physical items. The user can opt-in to a service via the application 661 to transmit information associated with the received input to the computing system 600, via the application 661. The user device 655 can transmit the input associated with the physical items as well as a location of the user device 655 to the computing system 600.

The user associated with the user device 655 can interface with the storage tower 100 which has transmitted/rendered the alert. The user can interface with the display 400 and/or the input device 404 of the storage tower 100 to select one or more physical items for retrieval. The controller 670 can control the transport apparatus 122 of the storage tower 100 to pick-up, transport, and deposit the one or more physical items in a storage receptacle 300 aligned/coupled with the front opening of the storage tower 100. The storage tower 100 can dispense the one or more physical items through the front opening.

As a non-limiting example, the autonomous object storage and retrieval system 650 can be implemented in a retail store environment. The storage tower 100 can be disposed in a retail store. The terminals 640 can be embodied as Point of Sale (POS) terminals, disposed in the retail store. The user can be customers shopping in the retail store. The customers can scan products to be purchased using the user device 655 while the application 661 is executed on the user device 655. Alternatively, or in addition to, the customers can scan products to be purchased at the POS terminals.

In one embodiment, the assignment module 620 can query the physical items database 625 to determine each of the products purchased a specified retail store over a period of time. The assignment module 620 can determine correlation or trend related information associated with the retail store. For example, the assignment module 620 can determine the demographics of customers frequenting the retail store, locations of the stores which are frequented by certain demographics, types of items purchased, and other correlation or trend related information associated with the retail store. The assignment module 620 can transmit instructions to load specific storage towers 100 with specified products or remove specific products from storage towers 100 based on the correlation or trend related information associated with the retail store. As a non-limiting example, the assignment module 620 can transmit instructions to remove a low selling product in a storage tower 100 in order to make room for the inbound physical item.

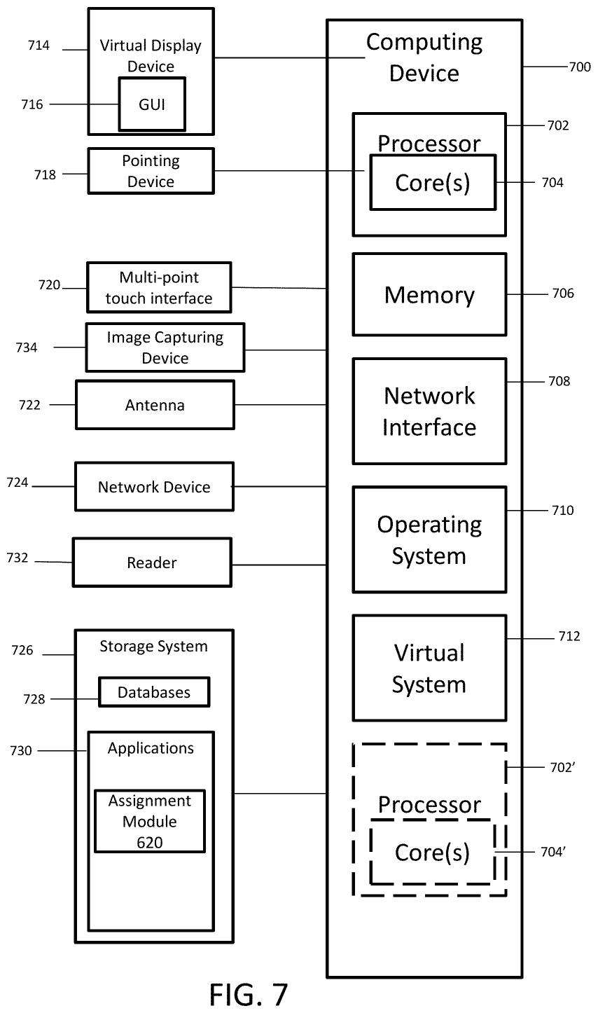

FIG. 7 is a block diagram of an example computing device for implementing exemplary embodiments of the present disclosure. The computing device 700 may be, but is not limited to, a smartphone, laptop, tablet, desktop computer, server or network appliance. The computing device 700 can be embodied as part of the computing system, user device, or storage tower. The computing device 700 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 706 included in the computing device 700 may store computer-readable and computer-executable instructions or software (e.g., applications 730 such as the assignment module 620) for implementing exemplary operations of the computing device 700. The computing device 700 also includes configurable and/or programmable processor 702 and associated core(s) 704, and optionally, one or more additional configurable and/or programmable processor(s) 702′ and associated core(s) 704′ (for example, in the case of computer systems having multiple processors/cores), for executing computer-readable and computer-executable instructions or software stored in the memory 706 and other programs for implementing exemplary embodiments of the present disclosure. The processor 702 and the processor(s) 702′ may each be a single core processor or multiple core (704 and 704′) processor. Either or both of the processor 702 and the processor(s) 702′ may be configured to execute one or more of the instructions described in connection with computing device 700.

Virtualization may be employed in the computing device 700 so that infrastructure and resources in the computing device 700 may be shared dynamically. A virtual machine 712 may be provided to handle a process running on multiple processors so that the process appears to be using only one computing resource rather than multiple computing resources. Multiple virtual machines may also be used with one processor.

Memory 706 may include a computer system memory or random access memory, such as DRAM, SRAM, EDO RAM, and the like. Memory 706 may include other types of memory as well, or combinations thereof.

A user may interact with the computing device 700 through a visual display device 714, such as a computer monitor, which may display one or more graphical user interfaces 716, multi touch interface 720, a pointing device 718, an image capturing device 734 and a scanner 732.

The computing device 700 may also include one or more computer storage devices 726, such as a hard-drive, CD-ROM, or other computer readable media, for storing data and computer-readable instructions and/or software that implement exemplary embodiments of the present disclosure (e.g., applications such as assignment module 620 as shown in FIG. 6 and application 661 as shown in FIG. 6). For example, exemplary storage device 726 can include one or more databases 728 for storing information regarding physical items and the storage towers. The databases 728 may be updated manually or automatically at any suitable time to add, delete, and/or update one or more data items in the databases.

The computing device 700 can include a network interface 708 configured to interface via one or more network devices 724 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 722 to facilitate wireless communication (e.g., via the network interface) between the computing device 700 and a network and/or between the computing device 700 and other computing devices. The network interface 708 may include a built-in network adapter, network interface card, PCMCIA network card, card bus network adapter, wireless network adapter, USB network adapter, modem or any other device suitable for interfacing the computing device 700 to any type of network capable of communication and performing the operations described herein.

The computing device 700 may run any operating system 710, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 700 and performing the operations described herein. In exemplary embodiments, the operating system 710 may be run in native mode or emulated mode. In an exemplary embodiment, the operating system 710 may be run on one or more cloud machine instances.

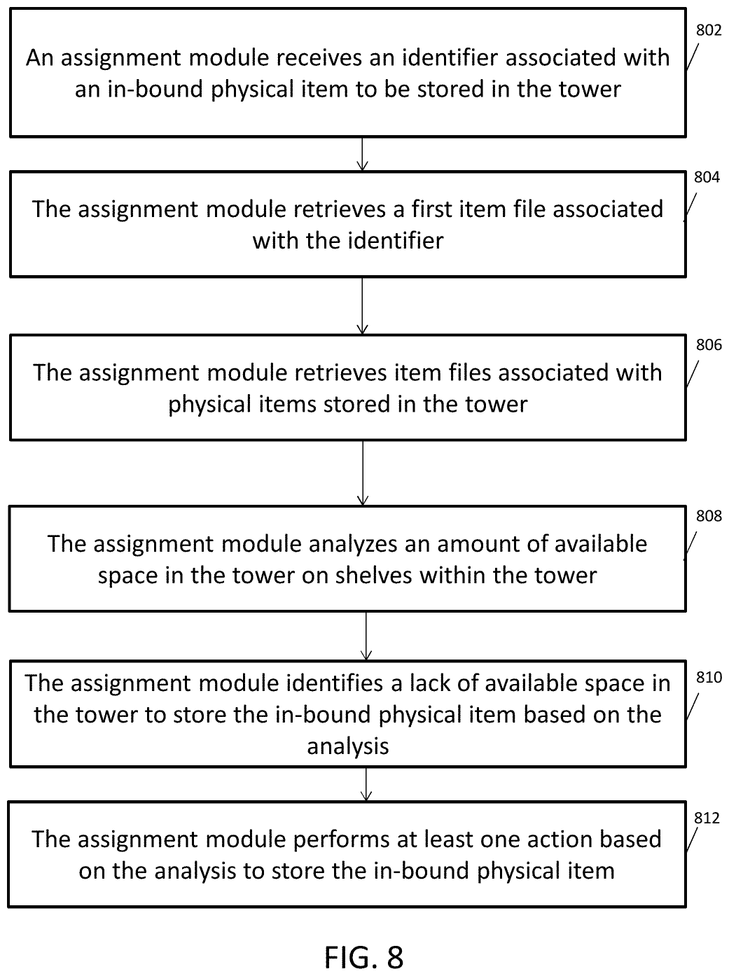

FIG. 8 is a flowchart illustrating a method for dynamic resizing of available space in an autonomous storage and retrieval tower, according to exemplary embodiment. In operation 802, an assignment module receives an identifier associated with an inbound physical item to be stored in the tower. In operation 804, the assignment module retrieves, from a storage device configured to store at least one item file associated with the at least one physical item and rules for organizing the trays, a first item file associated with the identifier, wherein the first item file has a first item dimension attribute associated with the inbound physical item. In operation 806, the assignment module retrieves item files associated with physical items stored in the tower, wherein the item files include item dimension attributes associated with the physical items stored in the tower. In operation 808, the assignment module analyzes an amount of available space in the tower on trays within the tower. In some embodiments, at least one tray can be moved in a vertical direction within the housing to change a distance between the tray and one or more of the remaining trays, based on the first item dimension attribute and the item dimension attributes associated with the physical items stored in the tower. In operation 810, the assignment module identifies a lack of available space in the tower to store the inbound physical item based on the analysis. In operation 812, the assignment module performs at least one action based on the analysis and a set of rules to store the inbound physical item.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

One or more of the exemplary embodiments, include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI is a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

The description is presented to enable a person skilled in the art to create and use a computer system configuration and related method and systems for receiving, storing, and dispensing free physical items from an autonomous storage and retrieval tower. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims. Other technical advantages may become readily apparent to one of ordinary skill in the art after review of the following figures and description.

What is claimed is:

1. An autonomous storage and retrieval tower with dynamic resizing of available space, comprising:
a housing;
a plurality of trays within the housing;
at least one computing device in communication with one or more databases that are configured to store at least one item file associated with the at least one physical item and rules for organizing the plurality of trays;
an assignment module executable by the computing device, the assignment module when executed:
receives an identifier associated with an inbound physical item to be stored in the tower;
retrieves, from the one or more databases, a first item file associated with the identifier, wherein the first item file has a first item dimension attribute associated with the inbound physical item;
retrieves a plurality of item files associated with a plurality of physical items stored in the tower, wherein the plurality of item files include item dimension attributes associated with the plurality of physical items stored in the tower;
analyzes an amount of available space in the tower on the plurality of trays based on the first item dimension attribute and the item dimension attributes associated with the plurality of physical items stored in the tower;
identifies a lack of available space in the tower to store the inbound physical item based on the analyzing; and
performs at least one action based on the analysis and the rules to store the in-bound physical item.

2. The tower of claim 1, further comprising:
at least one supporting unit containing a plurality of supports within the housing, each support of the plurality of supports configured to be to be able to move within the housing to change a distance between a tray and one or more of the remaining plurality of trays; and
the at least one computing device further configured to control movement of the plurality of supports,
wherein the at least one action includes changing a location of at least one support of the plurality of supports within the housing to make available space in the tower sufficient to store the inbound physical item.

3. The tower of claim 1, wherein the at least one action includes re-orienting a first physical item of the plurality of physical items stored in the tower to a different orientation on one of the plurality of trays.

4. The tower of claim 1, wherein the at least one action includes notifying an employee to re-orient a first physical item of the plurality of physical items stored in the tower to a different orientation on one of the plurality of trays.

5. The tower of claim 4, further comprising:
a screen configured to display a depiction of the item with the different orientation as part of the notifying.

6. The tower of claim 1, wherein the rules includes at least one of a length of time a physical item may be stored in the tower before being removed, specified categories associated with one or more physical items stored in the tower designating an order in which the one or more physical items are removed from the tower to make space in the tower, whether a physical item stored in the tower can be re-oriented, or whether a physical item stored in the tower can support weight.

7. The tower of claim 1, wherein the assignment module when executed performs the analysis by:
analyzing a location of each tray of the plurality of trays that holds a physical item based on an item dimension attribute of the physical item, and
analyzing categories of physical items stored within the tower.

8. The tower of claim 1, wherein the at least one action includes re-routing the inbound physical item to a different autonomous storage tower or a separate storage location.

9. The tower of claim 1, wherein the at least one action includes re-routing at least one physical item of the plurality of physical items stored in the tower to a different autonomous storage tower or a separate storage location.

10. The tower of claim 1, wherein the at least one action includes transmitting a notification to a customer to pick up a first physical item stored in the tower, where the first physical item is associated with the customer.

11. A method for dynamic resizing of available space in an autonomous storage and retrieval tower, comprising:
receiving, via an assignment module, an identifier associated with an inbound physical item to be stored in the tower;
retrieving, via the assignment module from a storage device configured to store at least one item file associated with the at least one physical item and rules for organizing a plurality of trays, a first item file associated with the identifier, wherein the first item file has a first item dimension attribute associated with the inbound physical item;
retrieving a plurality of item files associated with a plurality of physical items stored in the tower, wherein the plurality of item files includes item dimension attributes associated with the plurality of physical items stored in the tower;
analyzing an amount of available space in the tower on a plurality of trays within the tower based on the first item dimension attribute and the item dimension attributes associated with the plurality of physical items stored in the tower;
identifying a lack of available space in the tower to store the inbound physical item based on the analyzing; and
performing at least one action based on the analysis and the rules to store the inbound physical item.

12. The method of claim 11, wherein the at least one action includes changing, via the assignment module, a location of at least one tray of the plurality of trays within the housing to make available space in the tower sufficient to store the inbound physical item.

13. The method of claim 11, wherein the at least one action includes re-orienting, via the assignment module, a first physical item of the plurality of physical items stored in the tower to a different orientation on one of the plurality of trays.

14. The method of claim 11, wherein the at least one action includes notifying, via the assignment module, an employee to re-orient a first physical item of the plurality of physical items stored in the tower to a different orientation on one of the plurality of trays.

15. The method of claim 14, further comprising:
displaying on a screen a depiction of the item with the different orientation as part of the notifying.

16. The method of claim 11, wherein the rules includes at least one of a length of time a physical item may be stored in the tower before being removed, specified categories associated with one or more physical items stored in the tower designating an order in which the one or more physical items are removed from the tower to make space in the tower, whether a physical item stored in the tower can be re-oriented, or whether a physical item stored in the tower can support weight.

17. The method of claim 11, performing the analysis by:
analyzing, via the assignment module, a location of each tray of the plurality of trays that holds a physical item based on an item dimension attribute of the physical item, and
analyzing, via the assignment module, categories of physical items stored within the tower.

18. The method of claim 11, wherein the at least one action includes re-routing, via the assignment module, the inbound physical item to a different autonomous storage tower or a separate storage location.

19. The method of claim 11, wherein the at least one action includes re-routing, via the assignment module, at least one physical item of the plurality of physical items stored in the tower to a different autonomous storage tower or a separate storage location.

20. The method of claim 11, wherein the at least one action includes transmitting, via the assignment module, a notification to a customer to pick up a first physical item stored in the tower, where the first physical item is associated with the customer.
